(19) United States
(12) Patent Application Publication
(10) Pub. No.: US 2008/0116008 A1
(43) Pub. Date: May 22, 2008

(54) Ladder rack

(76) Inventors: Keith Charles Wass, West Denistone (AU); Peter Brian Munro, Arcadia (AU)

Correspondence Address: COHEN, PONTANI, LIEBERMAN & PAVANE, 551 FIFTH AVENUE, SUITE 1210, NEW YORK, NY, 10176, US

(21) Appl. No.: 11/986,364

(22) Filed: Nov. 21, 2007

(30) Foreign Application Priority Data
Nov. 22, 2006 (AU) 2006906511

(51) Int. Cl. E06C 5/02

(52) U.S. Cl. 182/127

(57) ABSTRACT

A modular ladder rack system for utility type vehicles in which the structure of the ladder rack is fabricated as separate unit or units from removable mounting feet via which it is secured to a vehicle; the ladder rack and mounting feet being adapted to be affixed to each other upon installation on a vehicle with the feet fitting relatively snugly inside a substantially vertical leg portion of the rack such that the leg portion hides the vertical upwardly extending portion of the foot.

### FIELD OF THE INVENTION

The present invention relates to ladder racks for pickup trucks or like utility type vehicles and in particular to a modular system for constructing same which facilitates compact packaging, and minimum stock requirements due to commonality of parts as between ladder racks for different vehicles.

### BACKGROUND OF THE INVENTION

For many years tradesmen have fitted ladder racks to trucks and passenger vehicle derivatives such as pickups or utility type vehicles. These ladder racks typically comprise hollow tubular metal sections having a vertical leg at either side of the vehicle supporting a horizontal section therebetween. The horizontal section is adapted to carry ladders, pipes, timber or other long articles which will not readily fit in the tray of the vehicle. The purpose of the vertical legs is to raise the horizontal section above cab or roof line of the vehicle and thereby facilitating the carrying of ladders or other articles in such a manner that they may overlie or overhang the cab or roof line of the vehicle. Sometimes only a front ladder rack is provided in order that long articles may rest on the rear floor of the tray and extend up over the roof line of the vehicle being supported only on the front just behind the roof of the vehicle by the ladder rack. Alternatively one ladder rack at the front of the tray and one ladder rack at the rear of the tray may be provided in order that loads may be carried substantially horizontally spanning the two ladder racks and leaving the tray of the vehicle free for use to carry other items apart from those on the ladder racks.

More recent developments that have dictated that yet more versions of ladder racks must be stocked by manufacturers and retailers include the popularity of roll tops for utility type vehicles. Roll tops are akin to roller doors or shutters which extend horizontally over the top of the tray in order to provide security. They require tracks along either side of the tray of the vehicle in order to guide, support and captivate the edges of the roll top generally and when it is being opened or closed. These tracks or rails extend longitudinally along the top of the sides of the tray and dictate that the feet of any ladder racks fitted to the vehicle cannot be bolted down the inside vertical sections of the sides of the tray but must rather be bolted flat on to the horizontal side rail or track in which the edges of the roll top run or onto an infill panel which is screwed to the sides of the tray of vehicles which have curved sides to give a straight edge to which to screw the horizontal side rail or track of the roll top.

In recent years such ladder racks have become fashion accessories which are designed to complement the appearance of vehicles such as for example being raked to match the “B” pillar of the vehicle. Typically modern ladder racks may be fabricated of large diameter aluminium tubing having a decorative satin or polished appearance. It is furthermore in the case then there are differing requirements for the substantially vertical members at either side of the ladder rack depending upon the angled rake of the vehicle and whether wide articles must be capable of being transported; for example to prevent items sliding laterally along the top of a bar small “rabbit's ears” may be provided at either side or alternatively lateral extensions outboard of the upper extremities of the vertical supports may be required if a wide load area is necessary to carry fiberboard wall sheeting or the like.

Different utility vehicles require different ladder racks having regard to the differing widths of the trays of such vehicles; the different profiles of the tray sides and upper flanges of the tray sides to which the ladder racks must be affixed as well as the differing heights of cabs and profiles of the rear of cabs to which the front ladder rack is often matched.

As existing ladder racks are typically one-piece it will be appreciated that manufacturers and retailers must stock a large number of very bulky and different ladder racks in order to provide the consumer with ready access to an appropriate ladder rack for the vehicle. The maintenance of large stock requirements is expensive both by reason of the value of the stock itself and by reason of the large space required to store such stock and transport such large items.

### OBJECT OF THE INVENTION

Accordingly it is an object of the present invention to ameliorate some of the above-mentioned difficulties associated with existing ladder racks or at least to provide the market with an alternative.

### SUMMARY OF THE INVENTION

According to one embodiment of the present invention there is provided a modular ladder rack system for utility type vehicles in which the substantially vertical members at either side of a ladder rack are fabricated as separate units to the substantially horizontal section intended to lie between said vertical members and being supported thereby; the vertical members and horizontal section being adapted to be affixed to each other upon installation on a vehicle.

According to a further aspect of the present invention there is provided a modular ladder rack system for utility type vehicles in which the structure of the ladder rack is fabricated as separate unit or units from removable mounting feet via which it is secured to a vehicle; ladder rack and mounting feet being adapted to be affixed to each other upon installation on a vehicle.

### BRIEF DESCRIPTION OF THE DRAWING

Two embodiments of the present invention will now be described with reference to the accompanying drawings in which:

FIG. 1 is a part transverse section through a front ladder rack and tray of a vehicle fitted with a roll top and;

FIG. 2 is a schematic part transverse section through a front ladder rack and tray of a vehicle not fitted with a roll top and;

FIG. 3 is a side elevation of a rear ladder rack and tray of a vehicle fitted with a roll top and;

FIG. 4 is a side elevation of a rear ladder rack and tray of a vehicle not fitted with a roll top.

FIG. 5 is a magnified view of the area surrounding reference numeral 5 of FIG. 1

FIG. 6 is a magnified view of the area surrounding reference numeral 5a of FIG. 2

### DETAILED DESCRIPTION OF PREFERRED EMBODIMENTS

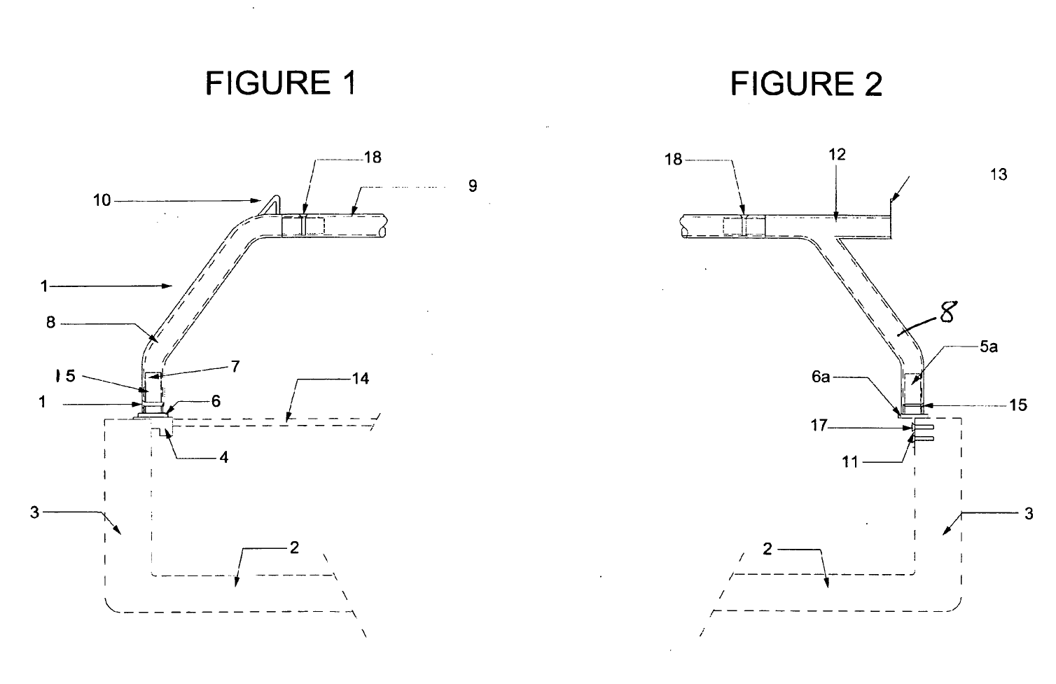

According to the embodiment of FIG. 1 there is provided a ladder rack 1 (only part shown) mounted on a ute tray 2 provided with a roll top 14 running in a horizontal rail 4 mounted on the inside top edge of the vertical side 3 of the utility vehicle tray 2.

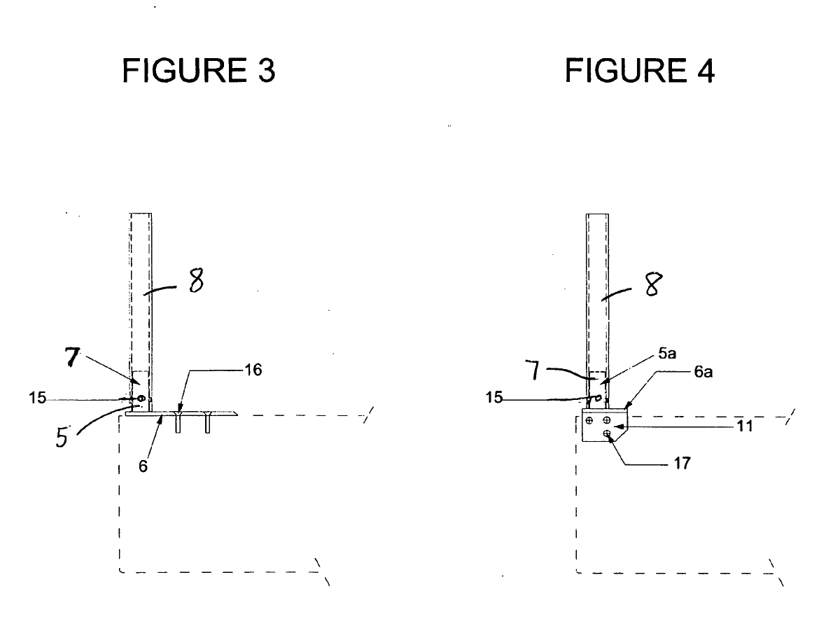

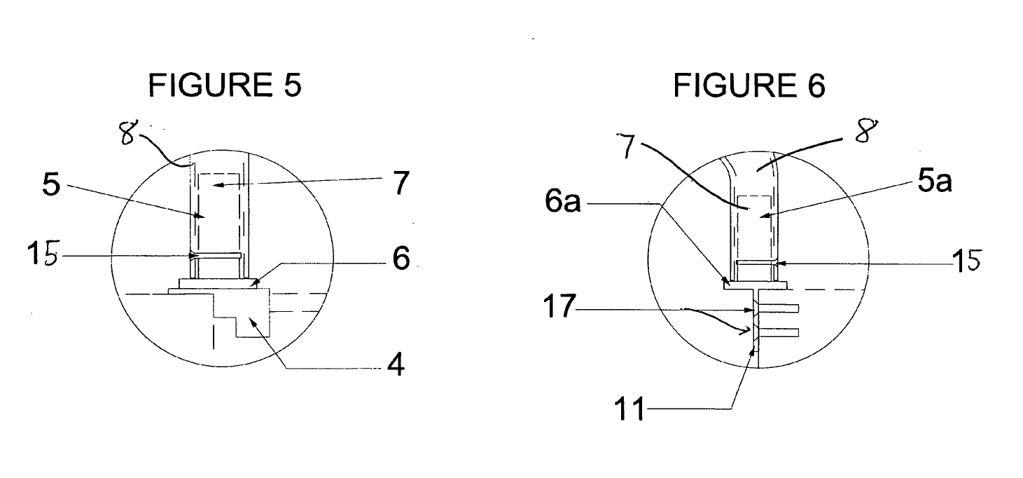

It will be appreciated that the embodiment of FIG. 1 is modular and incorporates a foot 5 incorporating a planar horizontal plate 6 (best viewed in FIG. 3) adapted to be screwed using screws 16 to horizontal rail 4 of roll top 14. The foot 5 incorporates an upstanding tubular portion 7 adapted to slip inside substantially vertical leg 8 which in turn is adapted to slip inside and support the central horizontal load carrying bar 9. Screws 18 may secure vertical legs 8 to load carrying bar 9 and screws 15 may secure feet 5 to verticals 8.

It will be appreciated that the substantially vertical leg 8 of this embodiment is angled inwardly for aesthetic reasons at an angle of approximately 30° from the vertical although this will vary depending upon the vehicle concerned. Furthermore it will be noted that the upper extremity of leg 8 is provided with a rabbit's ear 10 adjacent to its upper extremity in order to assist in locating items on load carrying bar 9 and preventing lateral movement of such loads occasioned by cornering of the vehicle.

It will be appreciated that a complimentary right-hand substantially vertical leg (not shown) and foot would be provided to complete the ladder bar depicted in FIG. 1. Hence the ladder rack depicted in FIG. 1 comprises five modular pieces being two feet, two substantially vertical legs and one horizontal load carrying bar therebetween all adapted to be securely located to each other once mounted upon a vehicle but capable of independent and compact storage. The load bar 9 may however in some embodiments be unitary (not shown) with the legs 8.

The longitudinal rake of the front ladder bar can be varied (not shown) to match the rake of the “B” pillar of a vehicle by utilizing different feet having upstanding portions 7 angled from the vertical with respect to base plates 6. Furthermore differing heights of ladder bars may be accommodated by utilizing common vertical legs which may be cut down to shorter lengths before being slipped onto the feet. Similarly the load carrying bars 9 may be stocked in the longest required length and then cut down in length to suit the width of a particular vehicle.

Turning now to FIG. 2 it will be noted that a utility vehicle tray 2 is depicted without the installation of a roll top 14. In this application a different foot 5a is utilized which includes a shorter horizontal base plate 6a (see FIG. 4) adapted to sit on the horizontal surface of the top of the side 3 of the ute tray. The foot also includes an additional plate 11 welded perpendicular to plate 6a and extending downwardly and substantially vertically to facilitate fixing the foot 5a to the inside vertical surface of the tray side 3 via bolts 17.

It will also be noted that the substantially vertical leg 8 depicted in FIG. 2 includes not the rabbit's ear 10 of the corresponding leg of FIG. 1 but rather a lateral extension 12 having an upstanding edge 13 so as to facilitate the carrying of wide planar articles requiring support such as fibreboard sheeting (not shown). Additionally a hole or holes (not shown) may be provided in upstanding edge 13 to facilitate the location of tie down hooks therein.

It will be appreciated that by stocking a variety of relatively small components in accordance with the modular system above described a large variety of vehicles and user requirements can be accommodated. For example the foot of FIG. 1 may be combined with the vertical leg 8 of FIG. 2 or vice versa. This system in accordance with the present invention has major advantages to vehicle owners as well as wholesalers and retailers as options like roll tops are often added by owners subsequent to purchase of vehicles and ladder racks. In such a situation as last mentioned where an owner adds a roll top to a vehicle after a ladder rack is installed the modular nature of the present invention allows the same ladder rack to be reinstalled on the vehicle by the simple relatively economical step of buying different feet adapted to bolt to a roll top rail rather than to the inside vertical surface of the tray. To facilitate this easy conversion the width of the front and rear ladder racks for a given vehicle, particularly when their horizontals and verticals are fabricated as one piece, should be sized so that the upright tubing straddles the transition from the inside vertical wall of the vehicle tray to the horizontal top of the side of the vehicle tray. It will be appreciated that the uprights depicted in FIGS. 1-4 hereof all span this transition so that relatively compact feet can be fabricated for any given vehicle whether fitted with a roll top or not.

From FIGS. 1-4 hereof it will be observed that the upstanding tubular portions 7 of the feet 5 are a relatively snug fit inside the vertical legs 8 and it is important for aesthetic reasons that the foot fit within the leg and not vice versa. In this way the foot is largely invisible and unobtrusive except for its horizontal plate 6.

The ladder racks of the present invention may advantageously be fabricated from relatively large diameter aluminium and the feet likewise from aluminium.

It should be appreciated that alternate embodiments apart from those above depicted and described may be devised without departing from the scope and intendment of the present invention and for example the method of fixing the feet to the vertical sections and the vertical sections to the horizontal sections by screws may be varied.

We claim:

1. A modular ladder rack system for utility type vehicles in which the structure of the ladder rack is fabricated as separate unit or units from removable mounting feet via which it is secured to a vehicle; the ladder rack and mounting feet adapted to be affixed to each other upon installation on a vehicle with the feet fitting relatively snugly inside a substantially vertical leg portion of the rack such that the leg portion hides the vertical upwardly extending portion of the foot.

2. The modular ladder rack system for utility type vehicles in accordance with claim 1 wherein the rack for a given vehicle is sized so that the vertical legs above each foot straddle the inside top edge of the vertical side of the utility vehicle tray.

3. The modular ladder rack system for utility type vehicles in accordance with claim 1 wherein the rack for a given vehicle is sized so that the vertical legs above each foot straddle the inside top edge of the vertical side of the utility vehicle tray; the vertical legs and the load carrying bar being fabricated as separate units.

4. The modular ladder rack system for utility type vehicles in accordance with claim 1 wherein the rack for a given vehicle is sized so that the vertical legs above each foot straddle the inside top edge of the vertical side of the utility vehicle tray; the vertical legs and the load carrying bar being fabricated as one piece.

5. The modular ladder rack system for utility type vehicles in accordance with claim 1 wherein the longitudinal rake of the front ladder bar can be varied to match the rake of the “B” pillar of a vehicle by utilizing different feet having upstanding portions angled from the vertical with respect to base plates.
